(19) United States
(12) Patent Application Publication
(10) Pub. No.: US 2021/0201330 A1
(43) Pub. Date: Jul. 1, 2021

(54) SYSTEM FOR DETECTING TARGET MERCHANTS AND COMPROMISED USERS CORRESPONDING TO FRAUDULENT TRANSACTIONS

(71) Applicant: Aetna Inc., Hartford, CT (US)

(72) Inventors: Salil Kumar Jain, Jackson Heights, NY (US); Venkata Naga C. Vinakota, Roanoke, TX (US)

(73) Assignee: Aetna Inc., Hartford, CT (US)

(21) Appl. No.: 16/729,939

(22) Filed: Dec. 30, 2019

(51) Int. Cl. G06Q 30/00; G06Q 50/26

(52) U.S. Cl. CPC G06Q 30/0185; G06Q 50/265

(57) ABSTRACT

A fraud detection system includes one or more processors and one or more non-transitory computer-readable mediums having processor-executable instructions stored thereon. The processor-executable instructions, when executed by the one or more processors, facilitate: obtaining a dataset of transaction data corresponding to a plurality of transactions between a plurality of users and a plurality of merchants; applying one or more filters to remove transaction data corresponding to certain transactions from the dataset; analyzing transaction data corresponding to remaining transactions of the dataset for detecting one or more potential target merchant(s) and/or for detecting one or more potentially comprised user(s); and outputting a detection result indicative of the one or more potential target merchant(s) and/or the one or more potentially comprised user(s).

### BACKGROUND

Identity theft is a major problem affecting millions of people worldwide. There are many ways in which identity theft may occur, including, for example, skimming of credit/debit cards using malicious card readers and hacking of online data repositories to illicitly obtain users' payment information. Fraudsters who obtain stolen payment information (e.g., directly through identity theft, through purchasing the information via the dark web, or through other means) will then attempt to use the stolen payment information for fraudulent transactions.

A fraudster often starts with one or more test transactions to see if the stolen payment information works, and if it does, the fraudster may then try to cash out as much as possible through one or more transactions with one or more merchant(s). These merchant(s) targeted by the fraudster (which may be referred to herein as “target merchant(s)”) may or may not knowingly be in a criminal enterprise with the fraudster. Oftentimes, the target merchant(s) merchants may simply have relatively weak security measures such that they are unable to detect the fraudulent nature of the transactions, and are thus chosen by the fraudster to process the fraudulent transaction(s).

### SUMMARY

In an exemplary embodiment, the present application provides a fraud detection system including one or more processors and one or more non-transitory computer-readable mediums having processor-executable instructions stored thereon. The processor-executable instructions, when executed by the one or more processors, facilitate: obtaining a dataset of transaction data corresponding to a plurality of transactions between a plurality of users and a plurality of merchants; applying one or more filters to remove transaction data corresponding to certain transactions from the dataset; analyzing transaction data corresponding to remaining transactions of the dataset for detecting one or more potential target merchant(s) and/or for detecting one or more potentially comprised user(s); and outputting a detection result indicative of the one or more potential target merchant(s) and/or the one or more potentially comprised user(s).

In a further exemplary embodiment, the transaction data for each transaction of the plurality of transactions comprises a category code; and applying the one or more filters comprises applying a category-based filter to remove transaction data corresponding to transactions having predetermined category codes.

In a further exemplary embodiment, the transaction data for each transaction of the plurality of transactions comprises a merchant ID; and applying the one or more filters comprises applying a trust-based filter to remove transaction data corresponding to transactions having certain merchant IDs corresponding to trusted merchants.

In a further exemplary embodiment, the trust-based filter is based on a whitelist comprising the certain merchant IDs corresponding to the trusted merchants.

In a further exemplary embodiment, the trusted merchants are merchants which have been known to a transaction processing entity for at least a certain amount of time.

In a further exemplary embodiment, the plurality of transactions of the obtained dataset corresponding to a certain time period, and wherein the transaction data for each transaction of the plurality of transactions comprises at least a merchant ID, a user ID, a timestamp and a category code.

In a further exemplary embodiment, analyzing the transaction data corresponding to the remaining transactions of the dataset to detect one or more potential target merchant(s) and/or to detect one or more potentially comprised user(s) comprises: determining, with respect to the remaining transactions of the dataset, for each respective merchant, a number of unique users corresponding thereto. The detection result is indicative of a respective merchant being a potential target merchant based on the respective merchant having at least a threshold number of unique users corresponding thereto.

In a further exemplary embodiment, the detection result is indicative of a respective user being a potentially compromised user based on the respective user having transacted with any potential target merchant.

In a further exemplary embodiment, determining, with respect to the remaining transactions of the dataset, for each respective merchant, the number of unique users corresponding thereto comprises: generating a mapping for each respective merchant which maps each respective merchant to a corresponding set of unique users which transacted with the respective merchant. And analyzing the transaction data corresponding to the remaining transactions of the dataset to detect one or more potential target merchant(s) and/or to detect one or more potentially comprised user(s) further comprises: removing, from the dataset, transaction data corresponding to transactions corresponding to merchants which do not have at least a threshold number of unique users corresponding thereto.

In a further exemplary embodiment, analyzing the transaction data corresponding to the remaining transactions of the dataset to detect one or more potential target merchant(s) and/or to detect one or more potentially comprised user(s) comprises: determining, with respect to the remaining transactions of the dataset, for each respective user, a number of unique merchants corresponding thereto. The detection result is indicative of a respective user being a potentially compromised user based on the respective user having at least a threshold number of unique merchants corresponding thereto.

In a further exemplary embodiment, determining, with respect to the remaining transactions of the dataset, for each respective user, the number of unique merchants corresponding thereto comprises: generating a mapping for each respective user which maps each respective user to a corresponding set of unique merchants which transacted with the respective user. And analyzing the transaction data corresponding to the remaining transactions of the dataset to detect one or more potential target merchant(s) and/or to detect one or more potentially comprised user(s) further comprises: removing, from the dataset, transaction data corresponding to transactions corresponding to users which do not have at least a threshold number of unique merchants corresponding thereto.

In a further exemplary embodiment, outputting the detection result comprising outputting the detection result on a display of the fraud detection system and/or sending the detection result to another computing device via a communication network.

In a further exemplary embodiment, the detection result includes: transaction data corresponding to the one or more potential target merchant(s) and/or the one or more potentially comprised user(s), an identification of the one or more potential target merchant(s), and/or an identification of the one or more potentially comprised user(s).

In a further exemplary embodiment, the processor-executable instructions, when executed by the one or more processors, further facilitate: executing a responsive operation in response to the detection result, wherein the responsive operation includes: communicating with one or more users regarding the detection result, and/or limiting or disabling usability of user information corresponding to the one or more potentially comprised user(s).

In a further exemplary embodiment, the dataset comprises transaction data for an amount of transactions on the order of thousands of transactions or more.

In a further exemplary embodiment, the one or more processors and the one or more non-transitory computer-readable mediums are configured to provide a big data warehouse for storing the obtained dataset and a big data analytics engine for applying the one or more filters, analyzing the transaction data, and outputting the detection result.

In another exemplary embodiment, the present application provides a fraud detection system having one or more processors and one or more non-transitory computer-readable mediums having processor-executable instructions stored thereon. The processor-executable instructions, when executed by the one or more processors, facilitate: obtaining a dataset of transaction data corresponding to a plurality of transactions between a plurality of users and a plurality of merchants, wherein the plurality of transactions of the obtained dataset corresponding to a certain time period, and wherein the transaction data for each transaction of the plurality of transactions comprises at least a merchant ID, a user ID, a timestamp and a category code;

applying one or more filters to remove transaction data corresponding to certain transactions from the dataset, wherein applying the one or more filters comprises: applying a category-based filter to remove transaction data corresponding to transactions having predetermined category codes; and applying a trust-based filter to remove transaction data corresponding to transactions having certain merchant IDs corresponding to trusted merchants;
analyzing transaction data corresponding to remaining transactions of the dataset for detecting one or more potential target merchant(s) and/or for detecting one or more potentially comprised user(s), wherein analyzing the transaction data corresponding to the remaining transactions of the dataset to detect one or more potential target merchant(s) and/or to detect one or more potentially comprised user(s) comprises: determining, with respect to the remaining transactions of the dataset, for each respective merchant ID, a number of unique user IDs corresponding thereto; and/or determining, with respect to the remaining transactions of the dataset, for each respective user ID, a number of unique merchant IDs corresponding thereto; and
outputting a detection result indicative of the one or more potential target merchant(s) and/or the one or more potentially comprised user(s),
wherein: the detection result is indicative of a respective merchant being a potential target merchant based on a merchant ID corresponding to the respective merchant having at least a threshold number of unique user IDs corresponding thereto, the detection result is indicative of a respective user being a potentially compromised user based on the respective user having transacted with any potential target merchant, and/or the detection result is indicative of a respective user being a potentially compromised user based on a user ID corresponding to the respective user having at least a threshold number of unique merchant IDs corresponding thereto.

In a further exemplary embodiment, the dataset comprises transaction data for an amount of transactions on the order of thousands of transactions or more, and wherein the one or more processors and the one or more non-transitory computer-readable mediums are configured to provide a big data warehouse for storing the obtained dataset and a big data analytics engine for applying the one or more filters, analyzing the transaction data, and outputting the detection result.

In yet another exemplary embodiment, the present application provides a fraud detection method. The fraud detection method includes:

obtaining, by a fraud detection system, a dataset of transaction data corresponding to a plurality of transactions between a plurality of users and a plurality of merchants, wherein the plurality of transactions of the obtained dataset corresponding to a certain time period, and wherein the transaction data for each transaction of the plurality of transactions comprises at least a merchant ID, a user ID, a timestamp and a category code;
applying, by the fraud detection system, one or more filters to remove transaction data corresponding to certain transactions from the dataset, wherein applying the one or more filters comprises: applying a category-based filter to remove transaction data corresponding to transactions having predetermined category codes; and applying a trust-based filter to remove transaction data corresponding to transactions having certain merchant IDs corresponding to trusted merchants;
analyzing, by the fraud detection system, transaction data corresponding to remaining transactions of the dataset for detecting one or more potential target merchant(s) and/or for detecting one or more potentially comprised user(s), wherein analyzing the transaction data corresponding to the remaining transactions of the dataset to detect one or more potential target merchant(s) and/or to detect one or more potentially comprised user(s) comprises: determining, with respect to the remaining transactions of the dataset, for each respective merchant ID, a number of unique user IDs corresponding thereto; and/or determining, with respect to the remaining transactions of the dataset, for each respective user ID, a number of unique merchant IDs corresponding thereto; and
outputting, by the fraud detection system, a detection result indicative of the one or more potential target merchant(s) and/or the one or more potentially comprised user(s), wherein: the detection result is indicative of a respective merchant being a potential target merchant based on a merchant ID corresponding to the respective merchant having at least a threshold number of unique user IDs corresponding thereto, the detection result is indicative of a respective user being a potentially compromised user based on the respective user having transacted with any potential target merchant, and/or the detection result is indicative of a respective user being a potentially compromised user based on a user ID corresponding to the respective user having at least a threshold number of unique merchant IDs corresponding thereto.

In a further exemplary embodiment, the dataset comprises transaction data for an amount of transactions on the order of thousands of transactions or more, and wherein the fraud detection system comprises a big data warehouse for storing the obtained dataset and a big data analytics engine for applying the one or more filters, analyzing the transaction data, and outputting the detection result.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a simplified illustration depicting an exemplary environment in which exemplary embodiments of the present application are applicable.

FIG. 2 is a simplified block diagram depicting an exemplary fraud detection system for detecting potential target merchant(s) and/or potentially compromised user(s) in accordance with an exemplary embodiment of the present application.

FIG. 3 is a timing diagram depicting an exemplary process for detecting potential target merchant(s) and/or potentially compromised user(s) and responding to the detection of potential target merchant(s) and/or potentially compromised user(s).

FIG. 4 is a flowchart illustrating an exemplary process for analyzing transaction data to detect potential target merchant(s) and/or potentially compromised user(s).

FIGS. 5A-5B are flowcharts illustrating exemplary implementations of the exemplary process for analyzing transaction data to detect potential target merchant(s) and/or potentially compromised user(s) depicted in FIG. 4.

### DETAILED DESCRIPTION

Some common situations involving fraudulent transactions include the following: (1) a fraudster obtains user information of a user (e.g., a user's payment information, such as credit card information, debit card information, or Health Savings Account (HSA) or Flexible Spending Account (FSA) card information) and uses it to conduct a plurality of fraudulent transactions at multiple merchants; (2) a fraudster obtains user information of multiple users (e.g., each of the multiple user's payment information) and uses it to conduct a plurality of fraudulent transaction at a single target merchant; or (3) a fraudster obtains user information of multiple users (e.g., each of the multiple user's payment information) and uses it to conduct a plurality of fraudulent transaction at multiple target merchants. Exemplary embodiments of the present application provide a fraud detection system that is able to analyze transaction data to detect potential target merchant(s) and/or potentially compromised users, as well as corresponding transactions with may be fraudulent, in the event that any of these common situations involving fraudulent transactions has occurred.

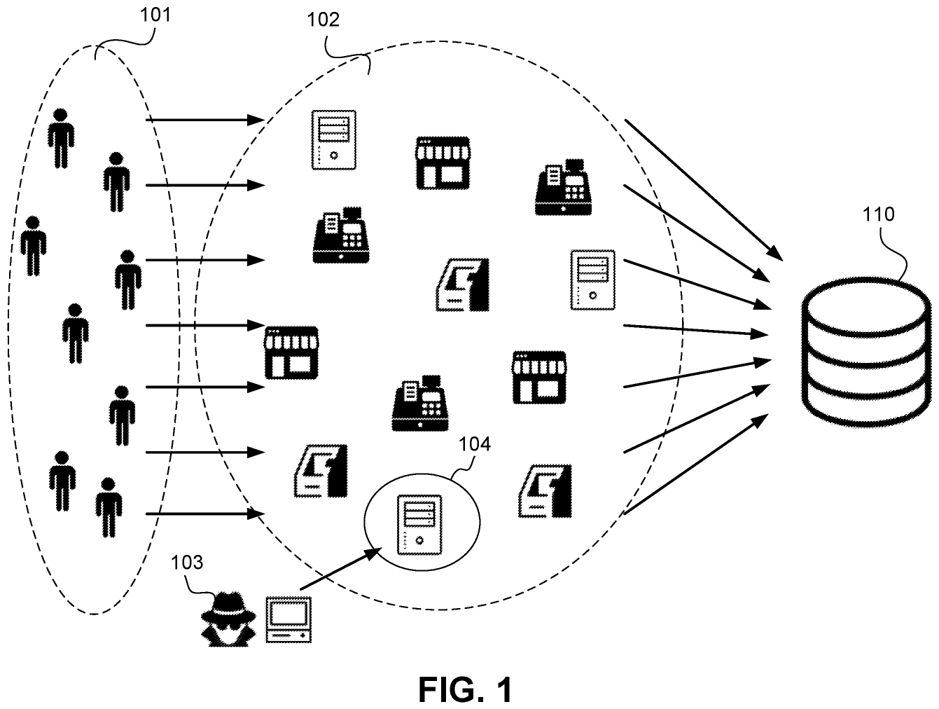

FIG. 1 is a simplified illustration depicting an exemplary environment in which exemplary embodiments of the present application are applicable. The exemplary environment includes a plurality of users 101 interacting with a plurality of merchants 102. The plurality of users 101 interacting with the plurality of merchants 102 may include, for example, in-person or online credit card transactions, debit card transactions, HSA card transactions, and/or FSA card transactions, as well as other types of transactions, such as automated teller machine (ATM) transactions. Transaction data corresponding to transactions conducted between the plurality of users 101 and the plurality of merchants is transmitted to and stored in a transaction database 110. The transaction data may include transaction data for successfully completed transactions as well as for declined transactions, and the term “transaction” may be used herein to refer to unsuccessful or declined transactions as well as successful transactions.

The plurality of merchants 102 may include entities such as businesses or persons which use devices such as ATMs, point-of-sale (POS) machines, servers or other devices to process transactions. The term “merchant” as used herein may refer to any entity or device where user information is used to carry out a transaction.

The plurality of merchants 102 may include one or more target merchants 104 which is/are targeted by a fraudster 103. For example, as depicted in FIG. 1, a fraudster 103 may use illicitly obtained user information corresponding to one or more users to conduct fraudulent transactions at one or more target merchants 104. The transaction data corresponding to these fraudulent transaction(s) is sent to and stored at the transaction database 110 along with other transaction data corresponding to other merchants 102, which may include transaction data corresponding to legitimate transactions.

It will be appreciated that the exemplary environment depicted in FIG. 1 is merely an example, and that the principles discussed herein may also be applicable to other situations—for example, including other types of merchants, other types of payment information, etc.

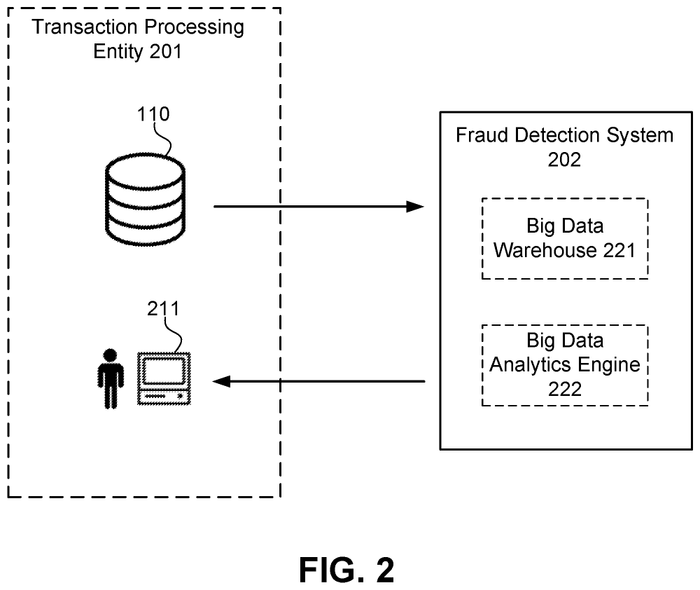

FIG. 2 is a simplified block diagram depicting an exemplary fraud detection system for detecting potential target merchant(s) and/or potentially compromised user(s) in accordance with an exemplary embodiment of the present application. In FIG. 2, the transaction database 110 of FIG. 1 is depicted as being part of a transaction processing entity 201, and the transaction database 110 of FIG. 1 is separate from and in communication (e.g., over a communication network via a wired or wireless connection) with a fraud detection system 202. The fraud detection system 202 may thus obtain transaction data from the transaction database 101, analyze the transaction data, and output a detection result back to a computing device 211 of the transaction processing entity 201 (e.g., over the same communication network via a wired or wireless connection). An employee of the transaction processing entity 201 may then review the detection result using the computing device 211, may implement responsive operations based on the detection result, and/or review automatic responsive operations implemented in response to the detection result.

For example, in the case of HSA or FSA cards associated with a healthcare entity, the healthcare entity may work with a transaction processing vendor to manage the HSA or FSA cards and the accounts and transactions associated therewith. Thus, the transaction processing vendor may be the transaction processing entity 201 which obtains and stores transaction data corresponding to HSA or FSA cards in transaction database 110, and the healthcare entity may operate the fraud detection system 202 which is in communication with and uses the transaction data from the transaction database 110 of the transaction processing entity 201.

It will be appreciated that the amount of transaction data being stored and processed constitutes an amount for which it would be impracticable or impossible for a person to manually analyze. For example, the amount of transaction data being stored and processed may be on the order of thousands of transactions or more, and may involve correspondingly large datasets (e.g., on the order of MBs or GBs or more). In an exemplary implementation, the transaction database 110 may be implemented as, for example, a structured query language (SQL) server. The transaction database 110 cooperates with a big data analytics engine 222 (for example, which may comprise a plurality of computing nodes and which may utilize Apache Spark) and a big data warehouse 221 (for example, which may comprise a plurality of distributed storage nodes and which may utilize Apache Hadoop and/or Hive) for ingestion of the data into the fraud detection system, processing of the data to detect potential target merchant(s) and/or potentially compromised user(s), and outputting of a detection result (for example, in the form of suspicious activity report, for example, containing transaction data in comma-separated value (CSV) format).

It will be appreciated that the network configuration depicted in FIG. 2 is merely an example, and that the principles discussed herein may also be applicable to other situations. For example, the fraud detection system may instead be operated as part of the transaction processing entity, with the transaction database being implemented as a big data warehouse directly accessible to the fraud detection system (in other words, transaction database 110 and big data warehouse 221 in FIG. 2 may be integrated as a single element, and fraud detection system 202 may be within the transaction processing entity 201), and such that an output of the fraud detection system (e.g., an output of a big data analytics engine) is directly available to an employee associated with the transaction processing entity. In another example, the fraud detection system may output a detection result to another entity (such as to a healthcare entity, to a user, or to some other interested entity to which the detection result is relevant), in addition to or instead of outputting the detection result to the transaction processing entity.

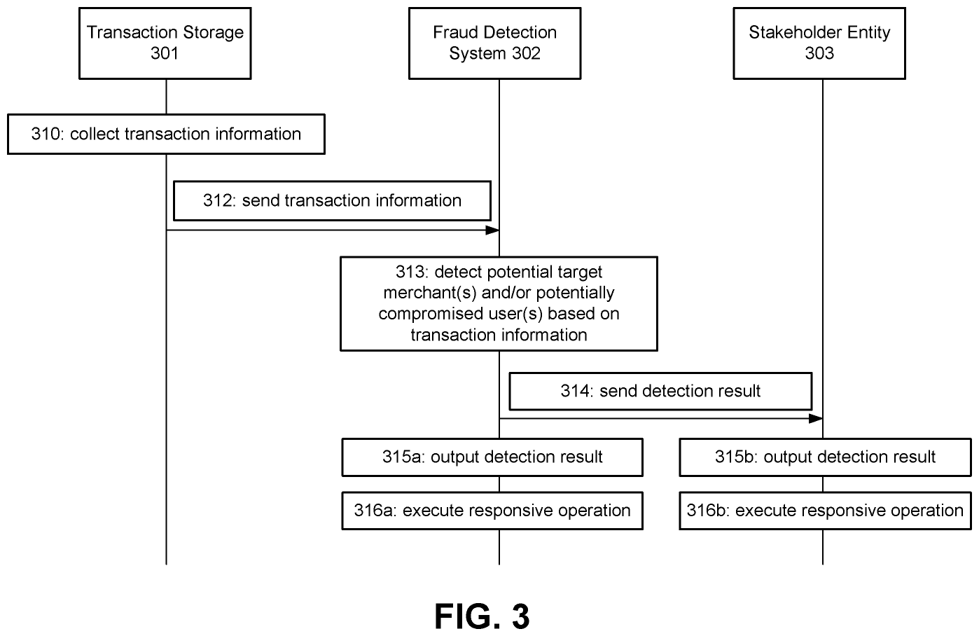

FIG. 3 is a timing diagram depicting an exemplary process for detecting potential target merchant(s) and/or potentially compromised user(s) and responding to the detection of potential target merchant(s) and/or potentially compromised user(s). It will be appreciated that although the example depicted in FIG. 3 depicts the transaction storage 301, the fraud detection system 302, and the stakeholder entity 303 as separate elements, all of the operations discussed herein with respect to FIG. 3 may be performed by a single entity, by two entities, by three entities, or by more than three entities in various exemplary implementations of the present application. For example, in one exemplary implementation, the stakeholder entity 303 may be the same entity as a transaction processing entity which manages the transaction storage 301. In another example, the transaction storage 301 may be integrated into the fraud detection system 302.

At stage 310, the transaction storage 301 (e.g., corresponding to transaction database 110 depicted in FIGS. 1 and 2) collects transaction information corresponding to transactions between a plurality of users and a plurality of merchants. This may include information regarding hundreds, thousands, or even millions of transactions from various transaction processing locations over a time period. At stage 312 the transaction data is sent from the transaction storage 301 to the fraud detection system 302. At stage 313, the fraud detection system 302 detects potential target merchant(s) and/or potentially compromised user(s) based on the transaction information.

At stages 314, 315a and 315b, a detection result is output at the fraud detection system 302 (stage 315a), and/or a detection result is sent to a stakeholder entity 303 (stage 314) and output at the stakeholder entity 303 (stage 315b). For example, the detection result may include a suspicious activity report (for example, having transaction data corresponding to potentially fraudulent transactions and/or indicating potential target merchant(s) and/or indicating potentially compromised user(s)). A person corresponding to the fraud detection system 302 and/or a person corresponding to the stakeholder entity 303 (such as a fraud analyst) may then review the suspicious activity report (and may perform further follow-up, if appropriate, such as contacting affected merchant(s) and/or user(s)) to confirm whether or not the potentially fraudulent transactions are actually fraudulent and/or to confirm the identified merchant(s) as being target merchant(s) and/or to confirm the identified user(s) as being compromised user(s). The person(s) may also be able to determine if there were false positives, and may decline to implement or disable responsive operations with regard to the false positives.

At stages 316a and 316b, a responsive operation may be executed by a computing device of the fraud detection system 302 and/or a responsive operation may be executed by a computing device of the stakeholder entity 303 in response to the detection result. Responsive operation(s) may be triggered automatically in response to the detection result, and/or responsive operation(s) may be initiated in response to a user input (e.g., based on a respective user having reviewed the outputted detection result and deciding to implement a responsive operation in response thereto). Responsive operations may include, but are not limited to, the following examples:
Contacting users (e.g., via phone call, text message, or email) to confirm whether or not a potentially fraudulent transaction was indeed fraudulent.
Notifying users (e.g., via phone call, text message, or email) regarding their user information being compromised and/or potentially compromised.
Putting monitoring in place for all user information or cards that have been used in fraudulent or potentially fraudulent transactions.
Deactivating user information or cards that have been used in fraudulent or potentially fraudulent transactions. This may further include, for example, automatically triggering the provision of new user information or cards to affected users, or disabling existing user information or cards temporarily and requiring users to contact a card issuing entity to request re-enabling of their cards.
Limiting user information or card usage to a certain category of products or services. For example, cards may be limited to only be usable for medical purchases.
Blocking future transactions from taking place at a target merchant, or implementing heightened security measures and/or monitoring with respect to a target merchant.

In an exemplary implementation, the analysis at stage 313 is conducted with regard to transaction data corresponding to transactions over a set time period, such as transactions having a timestamp that falls within the past 24 hours. The analysis at stage 313 may be repeated at regular intervals, for example, every 30 minutes. In other words, a rolling window of transaction data corresponding to the past 24 hours may be periodically analyzed every 30 minutes. Thus, after an initial execution of stages 310 and 312 with respect to collecting and sending transaction information corresponding to transactions performed within a first 24 hours, subsequent executions of stages 310 and 312 may include collecting and sending additional transaction information corresponding to transactions performed within the past 30 minutes and updating the dataset analyzed by the fraud detection system 302 (wherein updating the dataset analyzed by the fraud detection system 302 may include deleting the oldest data that is no longer within the rolling 24 hour window). It will be appreciated, however, that the present application is not limited to a specific time period or analysis interval—for example, a longer or shorter time period of transaction data may be used, and longer or shorter analysis intervals may be used. Alternatively, the analysis at stage 313 may be performed continuously, with detection results being output in real-time or nearly in real-time.

It will further be appreciated that duplicated reporting may be avoided, for example, by providing updated reports after the first report which do not repeat the same data. For example, if a potential target merchant is identified based on 3 transactions which occurred in the last 24 hours in a first report output by a first iteration of the analysis, and a second iteration of the analysis conducted 30 minutes later identifies the same potential target merchant based on those same 3 transactions, a second report output based on a second iteration of the analysis would not include that same identification (or would include an abbreviated form of the identification). On the other hand, if the second iteration of the analysis conducted 30 minutes later had identified the same potential target merchant based on those same 3 transactions plus an additional transaction, a second report output based on a second iteration of the analysis could include an identification of the same potential target merchant and the additional transaction corresponding thereto (or all 4 transactions corresponding thereto).

It will be appreciated that the allocation of functionality among the different elements depicted in FIG. 3 is merely an example, and that the principles discussed herein may also be applicable to other situations. For example, in an exemplary implementation, the transaction storage 301 may be integrated within the fraud detection system 302, and/or the stakeholder entity 303 may be the same entity that operates the fraud detection system 302, in which case stage 312 and/or stage 314 may not be needed.

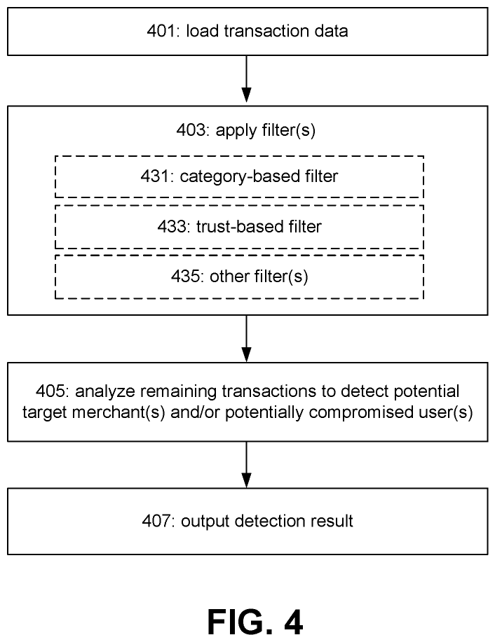

FIG. 4 is a flowchart illustrating an exemplary process for analyzing transaction data to detect potential target merchant(s) and/or potentially compromised user(s). The process depicted in FIG. 4 may be performed, for example, by a fraud detection system (e.g., fraud detection system 202 of FIG. 2 or fraud detection system 302 of FIG. 3. In an exemplary embodiment, the transaction data pertains to transactions performed using HSA and/or FSA card information. In other exemplary embodiments, the transaction data may pertain to other types of transactions.

At stage 401, transaction data is loaded into a computing system for analysis. The transaction data may be, for example, transaction data for a plurality of transactions (including successful and declined transactions) corresponding to a certain time period (such as a 24-hour window). The transaction data for each respective transaction may include a plurality of data elements. For example, in an exemplary implementation, the transaction data for a respective transaction may include the following parameters: user ID, username, transaction amount, category code (e.g., a Merchant Category Code (MCC)), country code, merchant location, merchant ID, merchant name, transaction timestamp, and declination indicator (e.g., indicating whether or not the transaction was declined, and if declined, the reason for declination). Loading the transaction data 401 may include loading all of the transaction data for the plurality of transactions corresponding to the relevant time period (e.g., loading all of the above-identified parameters), or may include loading a subset of the transaction data for each of the plurality of transactions corresponding to the relevant time period (e.g., loading certain parameters but not others, such as loading user ID, merchant ID, MCC, transaction timestamp, and declination indicator for each transaction).

At stage 403, the computing system applies one or more filters to remove transaction data from the dataset based on certain filter criteria.

For example, in the context of HSA and FSA cards, fraudulent transactions may be infrequent or non-existent with respect to certain MCC categories. Thus, at stage 431, a category-based filter may be applied to remove transaction data for transactions corresponding to a plurality of FSA/HSA allowed MCCs (e.g., including MCCs 4119, 5047, 5122, 5300, 5310, 5399, 5411, 5499, 5960, 5964, 5965, 5969, 5912, 5975, 5976, 7277, 8011, 8021, 8031, 8041, 8042, 8043, 8044, 8049, 8050, 8062, 8071, 8099, 8220 and 8398), HSA allowed MCCs (e.g., including MCCs 5099, 5661, 5719, 6399, 7278, 7299, 7394, 7699, 7997, 8299, 8999), transit and parking allowed MCCs (e.g., including MCCs 4111, 4112, 4121, 4131, 4784, 4789 and 7523), and dependent care allowed MCCs (e.g., including MCCs 8211 and 8351).

Additionally, a trust-based filter may be applied at stage 433 to exclude certain trusted merchants based on trust criteria. For example, the trust criteria may be based on a whitelist comprised of trusted merchants which have been known to a transaction processing entity for at least a certain amount of time (e.g., based on respective initial transactions for the merchants being at least 30 days old). It will be understood that, in some cases, these whitelisted merchants might not necessarily be “trusted,” but these whitelisted familiar merchants are to be checked using a different set of fraud detection framework relative to the procedures discussed herein.

In an exemplary embodiment, stages 431 and 435 may be combined based on building a whitelist table which includes at least a plurality of merchant ID entries with corresponding initial transaction dates (i.e., respective dates of respective first transactions processed by the transaction processing entity). The whitelist table may be populated based on two criteria: (1) merchants corresponding to allowed MCCs are added to the whitelist table; and (2) merchants having an initial transaction date earlier than a cutoff date are added to the whitelist table.

There may also be one or more other types of filters that may be used at stage 435. In an exemplary embodiment, certain transaction processing methods may be excluded—e.g., transactions processed via certain payment processors (such as PayPal and Square) may be excluded due to other rules being in place for fraud detection with respect to such transactions. In another exemplary embodiment, a de-duplication filter may be utilized to remove redundant transaction data such that multiple transaction data entries corresponding to a same transaction may be de-duplicated.

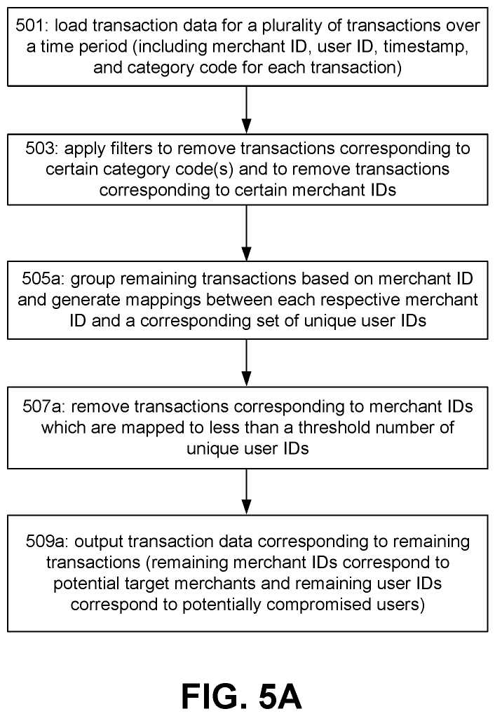

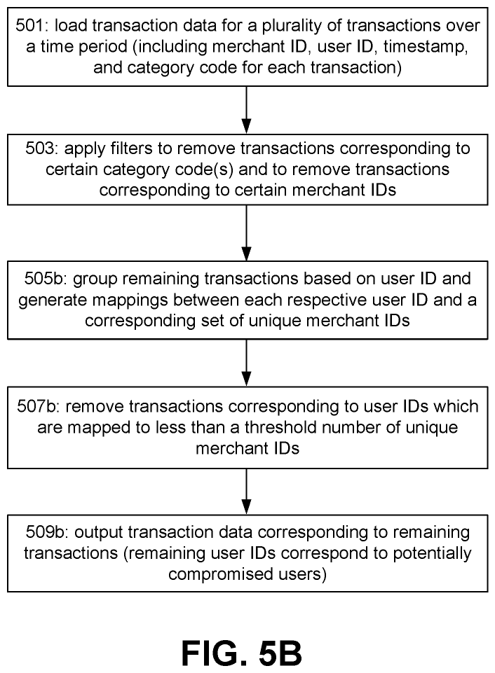

At stage 405, the remaining transactions of the dataset are analyzed by the computing system to detect potential target merchant(s) and/or potentially compromised user(s). This may include, for example, within the context of the remaining transactions of the dataset, determining for each unique merchant (based on merchant ID or merchant name) a number of unique users corresponding thereto (based on user ID or username) and/or determining for each unique user (based on user ID or username) a number of unique merchants corresponding thereto (based on merchant ID or merchant name). For example, as will be discussed below in an example corresponding to FIG. 5A, a potential target merchant and/or potentially compromised users, as well as corresponding transactions, can be identified based on the existence of at least a threshold number of unique users corresponding to a respective merchant, and as will be discussed below in an example corresponding to FIG. 5B, a potentially compromised user and transactions corresponding thereto can be identified based on the existence of at least a threshold number of unique merchants corresponding to a respective user.

At stage 407, a detection result (indicative of one or more potential target merchant(s) and/or indicative of one or more potentially compromised users) may be output, which may include outputting the detection result on a display of the computing system and/or sending the detection result to another computing device over a communication network. The detection result may include the transaction data for transactions corresponding to any merchant detected as being a potential target merchant and/or corresponding to any user detected as being a potentially compromised user. The detection result may provide this transaction data in the form of a suspicious activity report, may provide a list of potential target merchant(s) and/or may provide a list of potentially compromised user(s). The transaction data that is provided as part of the detection result may include the full transaction data for each transaction corresponding to a respective potential target merchant and/or a respective potentially compromised user (e.g., including user ID, username, transaction amount, category code, country code, merchant location, merchant ID, merchant name, transaction timestamp, and declination indicator), or the transaction data that is provided as part of the detection result may include a subset of transaction data for each transaction corresponding to a respective potential target merchant and/or a respective potentially compromised user (e.g., including only user ID, merchant ID, MCC, transaction timestamp).

In an alternative embodiment, only transaction data for successful transactions is loaded at stage 401 (or transaction data corresponding to unsuccessful or declined transactions is filtered out at stage 435) such that unsuccessful or declined transactions are ignored for the purposes of the process shown in FIG. 4. In this embodiment, merchant(s) are only identified as potential target merchant(s) and/or user(s) are only identified as potentially compromised user(s) if successful fraudulent transactions have taken place with respect to the corresponding merchant(s) and/or user(s).

FIGS. 5A-5B are flowcharts illustrating exemplary implementations of the exemplary process for analyzing transaction data to detect potential target merchant(s) and/or potentially compromised user(s) depicted in FIG. 4.

FIG. 5A illustrates a process for detecting potential target merchant(s) and potentially compromised user(s) based on analyzing a dataset of transaction data. At stage 501, transaction data for a plurality of transactions corresponding to a time period is loaded, wherein the transaction data includes, for each transaction, a merchant ID, a user ID, a timestamp, and a category code (e.g., an MCC). At stage 503, one or more filters is/are applied to remove transactions corresponding to certain category codes (e.g., removing from the dataset transaction data corresponding to transactions having certain MCCs) and to remove transactions corresponding to certain “trusted” merchants (e.g., removing from the dataset transaction data corresponding to transactions having certain merchant IDs corresponding to merchants for which an initial transaction was processed by the transaction processing entity at least 30 days ago). Other filters may also be applied at stage 503 (for example, as discussed above with respect to stage 403 of FIG. 4).

At stage 505a, the remaining transactions are grouped based on merchant ID, and mappings are generated between each respective merchant ID and a corresponding set of unique user IDs. To give a simple example, if the remaining dataset comprises transaction data corresponding to 5 transactions as follows—Transaction 1 (including Merchant ID=700, User ID=800, timestamp=2019-01-01 01:01:01); Transaction 2 (including Merchant ID=700, User ID=801, timestamp=2019-01-01 02:02:02); Transaction 3 (including Merchant ID=701, User ID=800, timestamp=2019-01-01 03:03:03); Transaction 4 (including Merchant ID=702, User ID=802, timestamp=2019-01-01 04:04:04); and Transaction 5 (including Merchant ID=703, User ID=802, timestamp=2019-01-01 05:05:05)—the following mappings would be generated: mapping 700 (800, 801); mapping 701 (800); mapping 702 (802); mapping 703 (802).

At stage 507a, transactions corresponding to merchant IDs which are mapped to less than a threshold number of unique user IDs are removed from the dataset. Thus, in the case of the simple example given above, if the threshold number is 2, the transactions corresponding to Merchant IDs 701, 702 and 703 are removed because Merchant IDs 701, 702 and 703 are each mapped to only one unique user ID (User ID 800).

At stage 509a, transaction data corresponding to remaining transactions is output as part of a detection result (and the remaining merchant ID(s) and user IDs in this transaction data correspond to potential target merchant(s) and potentially compromised users, respectively). Thus, in the case of the simple example given above, only the 2 transactions corresponding to Merchant ID 700 remain after stage 507a, and the transaction data for Transaction 1 and Transaction 2 is thus included in the detection result. Alternatively or in addition to this transaction data being included in the detection result, the output at stage 509a may include a list of merchants identified as being potential target merchants (in the case of the simple example given above, Merchant ID 700 and/or a corresponding merchant name would be included in this list), and/or a list of users identified as being potentially compromised users (in the case of the simple example given above, User IDs 800 and 801 and/or corresponding usernames would be included in this list). Thus, a detection result output at stage 509a may include a suspicious activity report including transaction data corresponding to potentially fraudulent transactions, a merchant list including an identification of potential target merchant(s), and/or a user list including an identification of potentially compromised users.

FIG. 5B illustrates a process for detecting potentially compromised user(s) based on analyzing a dataset of transaction data. Stages 501 and 503 of FIG. 5B may be executed in the same manner as discussed above with respect to stages 501 and 503 of FIG. 5A.

At stage 505b, the remaining transactions are grouped based on user ID, and mappings are generated between each respective user ID and a corresponding set of unique merchant IDs. To give a simple example, if the remaining dataset comprises transaction data corresponding to 5 transactions as follows—Transaction 1 (including Merchant ID=700, User ID=800, timestamp=2019-01-01 01:01:01); Transaction 3 (including Merchant ID=701, User ID=800, timestamp=2019-01-01 03:03:03); Transaction 2 (including Merchant ID=700, User ID=801, timestamp=2019-01-01 02:02:02); Transaction 4 (including Merchant ID=702, User ID=802, timestamp=2019-01-01 04:04:04); and Transaction 5 (including Merchant ID=703, User ID=802, timestamp=2019-01-01 05:05:05)—the following mappings would be generated: mapping 800 (700, 701); mapping 801 (700); mapping 802 (702, 703).

At stage 507b, transactions corresponding to user IDs which are mapped to less than a threshold number of unique merchant IDs are removed from the dataset. Thus, in the case of the simple example given above, if the threshold number is 2, the transactions corresponding to User ID 801 are removed because User ID 801 is mapped to only one unique merchant ID (Merchant ID 700).

At stage 509b, transaction data corresponding to remaining transactions is output as part of a detection result (and the remaining user ID(s) in this transaction data correspond to potentially compromised user(s)). Thus, in the case of the simple example given above, the 4 transactions corresponding to User IDs 800 and 802 remain after stage 507b, and the transaction data for Transaction 1, Transaction 3, Transaction 4 and Transaction 5 is thus included in the detection result. Alternatively or in addition to this transaction data being included in the detection result, the output at stage 509b may include a list of users identified as being potentially compromised users (in the case of the simple example given above, User IDs 800 and 802 and/or corresponding usernames would be included in this list). Thus, a detection result output at stage 509b may include a suspicious activity report including transaction data corresponding to potentially fraudulent transactions, and/or a user list including an identification of potentially compromised user(s).

The process depicted in FIG. 5A is suitable for detecting instances of fraud where a fraudster obtains user information of a user and uses it to conduct a plurality of fraudulent transactions at multiple target merchants. The process depicted in FIG. 5B is suitable for detecting instances of fraud where a fraudster obtains user information of multiple users and uses it to conduct a plurality of fraudulent transaction at a single target merchant. And both the processes depicted in FIGS. 5A and 5B are suitable for detecting instances of fraud where a fraudster obtains user information of multiple users and uses it to conduct a plurality of fraudulent transaction at multiple target merchants.

It will be appreciated that the processes of FIGS. 5A and 5B may be used together. For example, in an exemplary embodiment, after executing stages 501 and 503, a computing system may execute stages 505a and 507a to identify a first set of remaining transaction data (corresponding to potential target merchant(s) and potentially compromised users) and may execute stages 505b and 507b to identify a second set of remaining transaction data (corresponding to potentially compromised user(s)), and may combine the two sets of remaining transaction data (with de-duplication to account for transactions which appears in both sets) to generate and output a detection result that includes a suspicious activity report including transaction data corresponding to potentially fraudulent transactions, a merchant list including an identification of potential target merchant(s), and/or a user list including an identification of potentially compromised users. Referring to the simple examples discussed above, transaction data for all five transactions—Transaction 1, Transaction 2, Transaction 3, Transaction 4 and Transaction 5—would be included in the detection result, the merchant corresponding to Merchant ID 700 would be identified as being a potential target merchant, and/or users corresponding to User IDs 800, 801 and 802 would be identified as potentially compromised users.

It will be appreciated that the example thresholds discussed above with respect to FIGS. 5A-5B are merely exemplary, and that a higher threshold may be used. The values for the thresholds may be selected to balance sensitivity with the desire to avoid false positives.

In an exemplary implementation of FIG. 5A, transaction data of Optimized Row Columnar (ORC) format corresponding to HSA card transactions over a 24-hour time period was loaded. The dataset included ˜42,000 transactions and was ˜0.1 GB. At stage 503, an MCC-based filter was applied, which resulted in ˜40,500 of the transactions being removed from the dataset. A trust-based filter was also applied, which removed ˜100 merchants and ˜300 transactions from the dataset. At stages 505a, 507a and 509a, 1,200 remaining transactions were analyzed, with another 1,180 transactions being removed at stage 507a based on using a threshold of 2 for the threshold number of unique user IDs, and resulting in the transaction data corresponding to 20 transactions being output at stage 509a. Further follow-up was then performed with regard to potential target merchants and potentially compromised users indicated by the output result, leading to confirmation that at least some of these potential target merchants were indeed target merchants and that at least some of the potentially compromised users were indeed compromised users.

It will be appreciated that the above-discussed figures and corresponding descriptions are merely exemplary, and that the invention is not limited to these exemplary embodiments and implementations.

It will further be appreciated that the execution of the various machine-implemented processes and steps described herein may occur via the computerized execution of processor-executable instructions stored on a non-transitory computer-readable medium, e.g., random access memory (RAM), read-only memory (ROM), programmable read-only memory (PROM), volatile, nonvolatile, or other electronic memory mechanism. Thus, for example, the operations described herein as being performed by computing devices and/or components thereof may be carried out by according to processor-executable instructions and/or installed applications corresponding to software, firmware, and/or computer hardware.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

It will be appreciated that the embodiments of the invention described herein are merely exemplary. Variations of these embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A fraud detection system, comprising one or more processors and one or more non-transitory computer-readable mediums having processor-executable instructions stored thereon, wherein the processor-executable instructions, when executed by the one or more processors, facilitate:
obtaining a dataset of transaction data corresponding to a plurality of transactions between a plurality of users and a plurality of merchants;
applying one or more filters to remove transaction data corresponding to certain transactions from the dataset;
analyzing transaction data corresponding to remaining transactions of the dataset for detecting one or more potential target merchant(s) and/or for detecting one or more potentially comprised user(s); and
outputting a detection result indicative of the one or more potential target merchant(s) and/or the one or more potentially comprised user(s).

2. The system according to claim 1, wherein the transaction data for each transaction of the plurality of transactions comprises a category code; and
wherein applying the one or more filters comprises applying a category-based filter to remove transaction data corresponding to transactions having predetermined category codes.

3. The system according to claim 1, wherein the transaction data for each transaction of the plurality of transactions comprises a merchant ID; and
wherein applying the one or more filters comprises applying a trust-based filter to remove transaction data corresponding to transactions having certain merchant IDs corresponding to trusted merchants.

4. The system according to claim 3, wherein the trust-based filter is based on a whitelist comprising the certain merchant IDs corresponding to the trusted merchants.

5. The system according to claim 3, wherein the trusted merchants are merchants which have been known to a transaction processing entity for at least a certain amount of time.

6. The system according to claim 1, wherein the plurality of transactions of the obtained dataset corresponding to a certain time period, and wherein the transaction data for each transaction of the plurality of transactions comprises at least a merchant ID, a user ID, a timestamp and a category code.

7. The system according to claim 1, wherein analyzing the transaction data corresponding to the remaining transactions of the dataset to detect one or more potential target merchant(s) and/or to detect one or more potentially comprised user(s) comprises:
determining, with respect to the remaining transactions of the dataset, for each respective merchant, a number of unique users corresponding thereto;
wherein the detection result is indicative of a respective merchant being a potential target merchant based on the respective merchant having at least a threshold number of unique users corresponding thereto.

8. The system according to claim 7, wherein the detection result is indicative of a respective user being a potentially compromised user based on the respective user having transacted with any potential target merchant.

9. The system according to claim 7, wherein determining, with respect to the remaining transactions of the dataset, for each respective merchant, the number of unique users corresponding thereto comprises: generating a mapping for each respective merchant which maps each respective merchant to a corresponding set of unique users which transacted with the respective merchant; and
wherein analyzing the transaction data corresponding to the remaining transactions of the dataset to detect one or more potential target merchant(s) and/or to detect one or more potentially comprised user(s) further comprises: removing, from the dataset, transaction data corresponding to transactions corresponding to merchants which do not have at least a threshold number of unique users corresponding thereto.

10. The system according to claim 1, wherein analyzing the transaction data corresponding to the remaining transactions of the dataset to detect one or more potential target merchant(s) and/or to detect one or more potentially comprised user(s) comprises:
determining, with respect to the remaining transactions of the dataset, for each respective user, a number of unique merchants corresponding thereto;
wherein the detection result is indicative of a respective user being a potentially compromised user based on the respective user having at least a threshold number of unique merchants corresponding thereto.

11. The system according to claim 10, wherein determining, with respect to the remaining transactions of the dataset, for each respective user, the number of unique merchants corresponding thereto comprises: generating a mapping for each respective user which maps each respective user to a corresponding set of unique merchants which transacted with the respective user; and
wherein analyzing the transaction data corresponding to the remaining transactions of the dataset to detect one or more potential target merchant(s) and/or to detect one or more potentially comprised user(s) further comprises: removing, from the dataset, transaction data corresponding to transactions corresponding to users which do not have at least a threshold number of unique merchants corresponding thereto.

12. The system according to claim 1, wherein outputting the detection result comprising outputting the detection result on a display of the fraud detection system and/or sending the detection result to another computing device via a communication network.

13. The system according to claim 1, wherein the detection result includes:
transaction data corresponding to the one or more potential target merchant(s) and/or the one or more potentially comprised user(s),
an identification of the one or more potential target merchant(s), and/or
an identification of the one or more potentially comprised user(s).

14. The system according to claim 1, wherein the processor-executable instructions, when executed by the one or more processors, further facilitate:
executing a responsive operation in response to the detection result, wherein the responsive operation includes: communicating with one or more users regarding the detection result, and/or limiting or disabling usability of user information corresponding to the one or more potentially comprised user(s).

15. The system according to claim 1, wherein the dataset comprises transaction data for an amount of transactions on the order of thousands of transactions or more.

16. The system according to claim 15, wherein the one or more processors and the one or more non-transitory computer-readable mediums are configured to provide a big data warehouse for storing the obtained dataset and a big data analytics engine for applying the one or more filters, analyzing the transaction data, and outputting the detection result.

17. A fraud detection system, comprising one or more processors and one or more non-transitory computer-readable mediums having processor-executable instructions stored thereon, wherein the processor-executable instructions, when executed by the one or more processors, facilitate:
obtaining a dataset of transaction data corresponding to a plurality of transactions between a plurality of users and a plurality of merchants, wherein the plurality of transactions of the obtained dataset corresponding to a certain time period, and wherein the transaction data for each transaction of the plurality of transactions comprises at least a merchant ID, a user ID, a timestamp and a category code;
applying one or more filters to remove transaction data corresponding to certain transactions from the dataset, wherein applying the one or more filters comprises:
applying a category-based filter to remove transaction data corresponding to transactions having predetermined category codes; and
applying a trust-based filter to remove transaction data corresponding to transactions having certain merchant IDs corresponding to trusted merchants;
analyzing transaction data corresponding to remaining transactions of the dataset for detecting one or more potential target merchant(s) and/or for detecting one or more potentially comprised user(s), wherein analyzing the transaction data corresponding to the remaining transactions of the dataset to detect one or more potential target merchant(s) and/or to detect one or more potentially comprised user(s) comprises:
determining, with respect to the remaining transactions of the dataset, for each respective merchant ID, a number of unique user IDs corresponding thereto; and/or
determining, with respect to the remaining transactions of the dataset, for each respective user ID, a number of unique merchant IDs corresponding thereto; and
outputting a detection result indicative of the one or more potential target merchant(s) and/or the one or more potentially comprised user(s), wherein: the detection result is indicative of a respective merchant being a potential target merchant based on a merchant ID corresponding to the respective merchant having at least a threshold number of unique user IDs corresponding thereto, the detection result is indicative of a respective user being a potentially compromised user based on the respective user having transacted with any potential target merchant, and/or the detection result is indicative of a respective user being a potentially compromised user based on a user ID corresponding to the respective user having at least a threshold number of unique merchant IDs corresponding thereto.

18. The system according to claim 17, wherein the dataset comprises transaction data for an amount of transactions on the order of thousands of transactions or more, and wherein the one or more processors and the one or more non-transitory computer-readable mediums are configured to provide a big data warehouse for storing the obtained dataset and a big data analytics engine for applying the one or more filters, analyzing the transaction data, and outputting the detection result.

19. A fraud detection method, comprising:
obtaining, by a fraud detection system, a dataset of transaction data corresponding to a plurality of transactions between a plurality of users and a plurality of merchants, wherein the plurality of transactions of the obtained dataset corresponding to a certain time period, and wherein the transaction data for each transaction of the plurality of transactions comprises at least a merchant ID, a user ID, a timestamp and a category code;
applying, by the fraud detection system, one or more filters to remove transaction data corresponding to certain transactions from the dataset, wherein applying the one or more filters comprises:
applying a category-based filter to remove transaction data corresponding to transactions having predetermined category codes; and
applying a trust-based filter to remove transaction data corresponding to transactions having certain merchant IDs corresponding to trusted merchants;
analyzing, by the fraud detection system, transaction data corresponding to remaining transactions of the dataset for detecting one or more potential target merchant(s) and/or for detecting one or more potentially comprised user(s), wherein analyzing the transaction data corresponding to the remaining transactions of the dataset to detect one or more potential target merchant(s) and/or to detect one or more potentially comprised user(s) comprises:
determining, with respect to the remaining transactions of the dataset, for each respective merchant ID, a number of unique user IDs corresponding thereto; and/or
determining, with respect to the remaining transactions of the dataset, for each respective user ID, a number of unique merchant IDs corresponding thereto; and
outputting, by the fraud detection system, a detection result indicative of the one or more potential target merchant(s) and/or the one or more potentially comprised user(s), wherein: the detection result is indicative of a respective merchant being a potential target merchant based on a merchant ID corresponding to the respective merchant having at least a threshold number of unique user IDs corresponding thereto, the detection result is indicative of a respective user being a potentially compromised user based on the respective user having transacted with any potential target merchant, and/or the detection result is indicative of a respective user being a potentially compromised user based on a user ID corresponding to the respective user having at least a threshold number of unique merchant IDs corresponding thereto.

20. The method according to claim 19, wherein the dataset comprises transaction data for an amount of transactions on the order of thousands of transactions or more, and wherein the fraud detection system comprises a big data warehouse for storing the obtained dataset and a big data analytics engine for applying the one or more filters, analyzing the transaction data, and outputting the detection result.
